(19) United States
(12) Patent Application Publication
(10) Pub. No.: US 2011/0094320 A1
(43) Pub. Date: Apr. 28, 2011

(54) METHOD FOR EVALUATING DE-AGGLOMERATION/COAGULATION STABILITY OF AGGLOMERATES MATERIALS

(76) Inventors: Liang Hong, Midland, MI (US); Mladen Ladika, Midland, MI (US); Qiang Zhang, Fayetteville, AR (US); Jay D. Romick, Midland, MI (US)

(21) Appl. No.: 12/909,170

(22) Filed: Oct. 21, 2010

Related U.S. Application Data
(60) Provisional application No. 61/254,798, filed on Oct. 26, 2009.

(51) Int. Cl. G01N 15/02

(52) U.S. Cl. 73/865.5

(57) ABSTRACT

The present invention generally relates to a method for evaluating de-agglomeration/coagulation stability of one or more agglomerates materials.

### CROSS-REFERENCE TO RELATED APPLICATIONS

This is a §111(a) application from U.S. Provisional Application No. 61/254,798, filed Oct. 26, 2009, the contents of which are incorporated herein by reference.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention generally relates to a method for evaluating de-agglomeration/coagulation stability of one or more agglomerates materials.

2. Description of the Related Art

U.S. Pat. No. 6,931,950 B2 mentions a system and process for particulate analysis. The system includes a source of solid particles; a sampler apparatus attached to and integral with the source of solid particles which apparatus is adapted to enable removal of small amounts of sample material from the source; a sonication cell connected to the sampling apparatus which sonication cell receives, optionally conditions, and sonicates the small amounts of sample material; a sample analysis apparatus connected to the sonication cell which sample analysis apparatus is adapted to receive, optionally further condition, and analyze the resulting sonicated sample received from the sonication cell; and a liquid pump and liquid carrying lines adapted to: withdraw aliquots from the source; convey a withdrawn aliquot to the sonication cell and sample analysis apparatus; and flush the system free of residual aliquot contamination.

Merrington, J., et al. mention a high throughput method for determining stability of aqueous pigment dispersions (A High Throughput Method for Determining the Stability of Pigment Dispersions, Macromolecular Rapid Communications, 2006; 27:835-840). In certain aspects, the method employs a mixture comprising carbon black, water, and a polymeric dispersant-stabilizer for carbon black, the carbon black being incapable of being dispersed in the water to form a stable dispersion thereof without such a polymeric dispersant-stabilizer. The polymeric dispersant-stabilizers of Merrington, J. et al. consisted of salts of methyl methacrylate copolymers neutralized with 2-amino-2-methylpropanol. In certain aspects, the method comprises, among other steps, a serial (i.e., non-parallel) ultrasonication dispersion step and a parallel digital imaging and optical density (light transmittance) particle size analysis step. The serial ultrasonication dispersion step cannot be used for parallel sonication of a plurality of mixtures and requires too much time so that it is unsuitable for subjecting multiple carbon black samples to mechanical shear for mechanical de-agglomeration/coagulation stability testing before optical densities of earlier subjected samples deteriorate. Merrington, J. et al. show that carbon black in the absence of an effective dispersant-stabilizer experienced substantial optical density instability (e.g., sedimentation and settlement of carbon black). For example carbon black in a mixture with dispersant 9 of Merrington, J. et al. experienced an increase in light transmittance of about 33 percent (i.e., from about 135 to about 180) between 20 minutes and 22 hours after preparation of the mixture (see FIG. 4, page 839). Employing an effective dispersant-stabilizer with carbon black, however, would confound results of its de-agglomeration/coagulation stability testing.

Oldenburg, K. et al. mention a high throughput sonication for evaluating compound solubilization of organic compounds in dimethylsulfoxide in a high throughput screening plate or tube format (High Throughput Sonication: Evaluation for Compound Solubilization, Combinatorial Chemistry and High Throughput Screening, 2005; 8:499-512).

Chemical and allied industries desire a method that would be capable of, among other things, rapidly characterizing de-agglomeration/coagulation stability of a plurality of agglomerates materials, especially a plurality of heterogeneous agglomerates materials. Preferably, the method would lack, and thus not be subject to confounding effects of, an agglomerates dispersant. More preferably, a laboratory-scale version of the high throughput chemistry system comprises a parallel high throughput workflow, especially a parallel high throughput workflow applying in parallel a de-agglomeration/coagulation stress testing condition to the plurality of agglomerates materials. Such parallel high throughput workflow would be especially useful as a means for accelerating materials and formulations research and development in the agglomerates art.

### BRIEF SUMMARY OF THE INVENTION

The present invention relates to a method for evaluating de-agglomeration/coagulation stability of an agglomerates material in a test mixture subjected to a de-agglomeration/coagulation stress testing condition, the test mixture comprising a liquid diluent and agglomerates material, the agglomerates material comprising a particulate solid.

In a first embodiment, the present invention is a method for evaluating de-agglomeration/coagulation stability of an agglomerates material, the method comprising evaluating de-agglomeration/coagulation stability of an agglomerates material as a function of a difference in particle sizes, or a statistical characterization thereof, of the agglomerates material before and after subjecting a test mixture comprising the agglomerates material contained in a liquid diluent to a de-agglomeration/coagulation stress testing condition.

In a second embodiment, the present invention is a parallel high throughput method for evaluating de-agglomeration/coagulation stability of a plurality of agglomerates materials, the method comprising independently evaluating de-agglomeration/coagulation stability of each of a plurality of agglomerates materials as a function of a difference in particle sizes, or a statistical characterization thereof, of the agglomerates material before and after essentially simultaneously subjecting a plurality of test mixtures, each test mixture independently comprising a different one of the plurality of the agglomerates materials contained in a liquid diluent, to a de-agglomeration/coagulation stress testing condition.

The invention method (i.e., invention method of the first or second embodiment) is useful in any procedure, process, or method that could benefit from evaluating de-agglomeration/coagulation stability of agglomerates material. The invention method is especially useful in manufacturing operations such as, for example, agglomerates material manufacturing and manufacturing operations employing agglomerates material as a feedstock. The invention method is particularly beneficial to such manufacturing operations having at least one result-effective variable, where the at least one result-effective variable is capable of being modified (e.g., improved) based on a learning of the de-agglomeration/coagulation stability of agglomerates material. Thus, in some embodiments, the invention method is useful in a quality control/quality assurance paradigm.

The invention method is adaptable for use in a laboratory-scale version of a parallel high throughput chemistry system comprising a parallel high throughput testing workflow. The invention parallel high throughput testing workflow and method applies in parallel a de-agglomeration/coagulation stress testing condition and performs in parallel a particle size analysis to evaluate the particle sizes, or a statistical characterization thereof. The invention parallel high throughput testing workflow and method adds to the art a method that can be completed before any appreciable sedimentation and settlement of agglomerates materials in the test mixtures can occur. Such parallel high throughput testing workflow and method would be especially useful as a means for accelerating materials and formulations research and development on agglomerates materials having appreciable sedimentation and settlement rates in the liquid diluent.

Additional embodiments are described in accompanying drawing(s) and the remainder of the specification, including the claims.

### BRIEF DESCRIPTION OF THE DRAWING(S)

Some embodiments of the present invention are described herein in relation to the accompanying drawing(s), which will at least assist in illustrating various features of the embodiments.

(FIG. 1A1 to FIG. 1A6 respectively show photographic images of different agglomeration materials of test mixtures of Examples 1 to 6, all at magnification of 1.6 times.

FIGS. 2A1 to 2A6 respectively show photographic images of different of agglomeration materials of test mixtures of Examples 7 to 12, all at magnification of 1.6 times.

### DETAILED DESCRIPTION OF THE INVENTION

The present invention generally relates to a method for evaluating de-agglomeration/coagulation stability of one or more agglomerates materials as summarized previously.

For purposes of United States patent practice and other patent practices allowing incorporation of subject matter by reference, the entire contents—unless otherwise indicated—of each U.S. patent, U.S. patent application, U.S. patent application publication, PCT international patent application and WO publication equivalent thereof, referenced in the instant Summary or Detailed Description of the Invention are hereby incorporated by reference. In an event where there is a conflict between what is written in the present specification and what is written in a patent, patent application, or patent application publication, or a portion thereof that is incorporated by reference, what is written in the present specification controls.

In the present application, any lower limit of a range of numbers, or any preferred lower limit of the range, may be combined with any upper limit of the range, or any preferred upper limit of the range, to define a preferred aspect or embodiment of the range. Each range of numbers includes all numbers, both rational and irrational numbers, subsumed within that range (e.g., the range from about 1 to about 5 includes, for example, 1, 1.5, 2, 2.75, 3, 3.80, 4, and 5).

In an event where there is a conflict between a unit value that is recited without parentheses, e.g., 2 inches, and a corresponding unit value that is parenthetically recited, e.g., (5 centimeters), the unit value recited without parentheses controls.

As used herein, “a,” “an,” “the,” “at least one,” and “one or more” are used interchangeably. In any aspect or embodiment of the instant invention described herein, the term “about” in a phrase referring to a numerical value may be deleted from the phrase to give another aspect or embodiment of the instant invention. In the former aspects or embodiments employing the term “about,” meaning of “about” can be construed from context of its use. Preferably “about” means from 90 percent to 100 percent of the numerical value, from 100 percent to 110 percent of the numerical value, or from 90 percent to 110 percent of the numerical value. In any aspect or embodiment of the instant invention described herein, the open-ended terms “comprising,” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of,” and the like to give another aspect or embodiment of the instant invention. In the present application, when referring to a preceding list of elements (e.g., ingredients), the phrases “mixture thereof,” “combination thereof,” and the like mean any two or more, including all, of the listed elements. The term “or” used in a listing of members, unless stated otherwise, refers to the listed members individually as well as in any combination, and supports additional embodiments reciting any one of the individual members (e.g., in an embodiment reciting the phrase “10 percent or more,” the “or” supports another embodiment reciting “10 percent” and still another embodiment reciting “more than 10 percent.”). The term “plurality” means two or more, wherein each plurality is independently selected unless indicated otherwise. The symbols “≦” and “≧” respectively mean less than or equal to and greater than or equal to. The symbols “<” and “>” respectively mean less than and greater than.

As described previously, the method of the present invention evaluates de-agglomeration/coagulation stability of the agglomerates material by determining and comparing particle sizes, or a statistical characterization thereof, of the agglomerates material before and after subjecting the test mixture comprising the agglomerates material contained in a liquid diluent to a de-agglomeration/coagulation stress testing condition. The term “test mixture” means “pre-test mixture” before and “stressed test mixture” after the subjecting step. The term “statistical characterization” when referring to particle sizes means a mathematical result derived using statistics. Examples of statistical characterizations are a statistical distribution of particle sizes, mean particle size, and median particle size. The term “de-agglomeration/coagulation” means de-agglomeration, coagulation, or de-agglomeration and coagulation. Preferably, de-agglomeration/coagulation means coagulation and, more preferably, de-agglomeration. Each de-agglomeration/coagulation stress testing condition independently may be the same as or different than another de-agglomeration/coagulation stress testing condition.

Preferably, the de-agglomeration/coagulation stress testing condition comprises a mechanical de-agglomeration stress testing condition, chemical de-agglomeration stress testing condition, electrical stress testing condition, or a combination thereof. In some embodiments, the combination comprises a combination of the mechanical and chemical de-agglomeration stress testing conditions. In some embodiments, the combination comprises a combination of the electrical and chemical de-agglomeration stress testing conditions.

The mechanical de-agglomeration stress testing condition comprises mechanical shear, the mechanical shear functioning in such a way that it is capable of producing at least a detectable partial de-agglomeration of the agglomerates material in the pre-test mixture. The chemical de-agglomeration stress testing condition comprises one or more chemical de-agglomerating agents. The electrical stress testing condition comprises applied electrical potential. The mechanical and chemical de-agglomeration stress testing conditions comprise a combination of the mechanical shear and one or more of the chemical de-agglomerating agents, the test mixture being sequentially or, preferably, simultaneously subjected to the mechanical shear and chemical de-agglomerating agent(s).

In some embodiments, for each agglomerates material the invention method independently comprises evaluating mechanical de-agglomeration stability of an agglomerates material as a function of a difference in particle sizes, or a statistical characterization thereof, of the agglomerates material before and after subjecting the test mixture comprising the agglomerates material contained in a liquid diluent to the mechanical de-agglomeration stress testing condition. Preferably, the mechanical de-agglomeration stress testing method comprises:
(a) providing a pre-test mixture comprising the agglomerates material and the liquid diluent, the agglomerates material being contained in the liquid diluent;
(b) determining particle sizes, or the statistical characterization thereof, of the agglomerates material in the pre-test mixture;
(c) subjecting the pre-test mixture to the mechanical de-agglomeration stress testing condition, thereby producing a mechanically stressed test mixture comprising a mechanically stressed agglomerates material and the liquid diluent, the mechanically stressed agglomerates material being contained in the liquid diluent;
(d) determining particle sizes, or the statistical characterization thereof, of the mechanically stressed agglomerates material of the mechanically stressed test mixture; and
(e) determining at least one difference in the particle sizes, or the statistical characterizations thereof, between the agglomerates material of the pre-test mixture and the mechanically stressed agglomerates material of the mechanically stressed test mixture.
   Preferably in the mechanical de-agglomeration stress testing method, the particle sizes, or the statistical characterizations thereof, are normalized for any de-agglomeration activity attributable to the liquid diluent. More preferably, the liquid diluent is characterizable as being essentially chemically inert towards the agglomerates material of the pre-test mixture and the mechanically stressed agglomerates material of the mechanically stressed test mixture, still more preferably the inert liquid diluent is characterizable as lacking substantial (i.e., greater than 5%), and more preferably lacking detectable, de-agglomeration activity under the mechanical de-agglomeration stress testing condition except in the absence of mechanical shear.

In some embodiments, for each agglomerates material the invention method independently comprises evaluating electrical de-agglomeration stability of an agglomerates material as a function of a difference in particle sizes, or a statistical characterization thereof, of the agglomerates material before and after subjecting the test mixture comprising the agglomerates material contained in a liquid diluent to the electrical de-agglomeration stress testing condition. Preferably, the electrical de-agglomeration stress testing method comprises:
(a) providing a pre-test mixture comprising the agglomerates material and the liquid diluent, the agglomerates material being contained in the liquid diluent;
(b) determining particle sizes, or the statistical characterization thereof, of the agglomerates material in the pre-test mixture;
(c) subjecting the pre-test mixture to the electrical de-agglomeration stress testing condition, thereby producing an electrically stressed test mixture comprising a electrically stressed agglomerates material and the liquid diluent, the electrically stressed agglomerates material being contained in the liquid diluent;
(d) determining particle sizes, or the statistical characterization thereof, of the electrically stressed agglomerates material of the electrically stressed test mixture; and
(e) determining at least one difference in the particle sizes, or the statistical characterizations thereof, between the agglomerates material of the pre-test mixture and the electrically stressed agglomerates material of the electrically stressed test mixture.

In some embodiments, for each agglomerates material the invention method independently comprises evaluating chemical de-agglomeration stability of an agglomerates material as a function of a difference in particle sizes, or a statistical characterization thereof, of the agglomerates material before and after subjecting the test mixture comprising the agglomerates material contained in a liquid diluent to the chemical de-agglomeration stress testing condition. Preferably, the chemical de-agglomeration stress testing method comprises:
(a) providing a pre-test mixture comprising the agglomerates material and the liquid diluent, the agglomerates material being contained in the liquid diluent;
(b) determining particle sizes, or the statistical characterization thereof, of the agglomerates material in the pre-test mixture;
(c) contacting the agglomerates material in the pre-test mixture to a chemical de-agglomeration agent, thereby producing a chemically stressed test mixture comprising a chemically stressed agglomerates material, the liquid diluent, and the chemical de-agglomeration agent, or a reaction product thereof, the chemically stressed agglomerates material being contained in the liquid diluent;
(d) determining particle sizes, or the statistical characterization thereof, of the chemically stressed agglomerates material of the chemically stressed test mixture; and
(e) determining at least one difference in the particle sizes, or the statistical characterizations thereof, between the agglomerates material of the pre-test mixture and the chemically stressed agglomerates material of the chemically stressed test mixture.
   Preferably, the contacting step is performed without the pre-test mixture being subjected to mechanical shear. In a further embodiment, steps (c) to (e) are repeated only this time in the presence of mechanical shear, thereby allowing the de-agglomerating effects of the chemical de-agglomeration agent and mechanical shear to be compared with each other.

In some embodiments, for each agglomerates material the invention method independently comprises evaluating mechanical and chemical de-agglomeration stability of an agglomerates material as a function of a difference in particle sizes, or a statistical characterization thereof, of the agglomerates material before and after subjecting the test mixture comprising the agglomerates material contained in a liquid diluent to the mechanical and chemical de-agglomeration stress testing conditions. Preferably, the mechanical and chemical de-agglomeration stress testing method comprises:
(a) providing a pre-test mixture comprising the agglomerates material and the liquid diluent, the agglomerates material being contained in the liquid diluent;
(b) determining particle sizes, or the statistical characterization thereof, of the agglomerates material in the pre-test mixture;
(c) contacting the agglomerates material in the pre-test mixture to a chemical de-agglomeration agent, thereby producing a chemically stressed test mixture comprising a chemically stressed agglomerates material, the liquid diluent, and the chemical de-agglomeration agent, or a reaction product thereof, the chemical de-agglomeration agent and the liquid diluent being the same or different, the chemically stressed agglomerates material being contained in the liquid diluent;
(d) subjecting the chemically stressed test mixture to the mechanical stress testing condition, thereby producing a chemically and mechanically stressed test mixture comprising a chemically and mechanically stressed agglomerates material, the liquid diluent, and the chemical de-agglomeration agent, or a reaction product thereof, the chemically and mechanically stressed agglomerates material being contained in the liquid diluent;
(e) determining particle sizes, or the statistical characterization thereof, of the chemically and mechanically stressed agglomerates material of the chemically and mechanically stressed test mixture; and
(f) determining at least one difference in the particle sizes, or the statistical characterizations thereof, between the agglomerates material of the pre-test mixture and the chemically and mechanically stressed agglomerates material of the chemically and mechanically stressed test mixture.

Preferably, the contacting step (c) and subjecting step (d) are essentially simultaneously performed. Preferably in the mechanical and chemical de-agglomeration stress testing method, the chemical de-agglomeration agent and the liquid diluent are different and the particle sizes, or the statistical characterizations thereof, are normalized for any de-agglomeration activity attributable to the liquid diluent. More preferably, the liquid diluent is characterizable as lacking substantial (i.e., greater than 5%), and more preferably lacking detectable, de-agglomeration activity under the mechanical and chemical de-agglomeration stress testing condition except in the absence of mechanical shear.

In some embodiments, for each agglomerates material the invention method independently comprises evaluating electrical and chemical de-agglomeration stability of an agglomerates material as a function of a difference in particle sizes, or a statistical characterization thereof, of the agglomerates material before and after subjecting the test mixture comprising the agglomerates material contained in a liquid diluent to the electrical and chemical de-agglomeration stress testing conditions. Preferably, the electrical and chemical de-agglomeration stress testing method comprises the immediately preceding steps (a) to (f) except where “mechanical” and “mechanically” are respectively replaced by “electrical” and “electrically.” Preferably, the contacting step (c) and subjecting step (d) are essentially simultaneously performed.

De-agglomeration/coagulation stress testing conditions comprise, for example, one or more of the following: amount of energy imparted to the test mixture by mechanical shear; temperature and pressure of the test mixture; length of time the test mixture is subjected to the de-agglomeration/coagulation stress testing condition(s); nature of chemical reactivity (e.g., acid, base, nucleophile, electrophile, and oxidant, reductant) of the chemical de-agglomeration agent; degree of chemical reactivity of the chemical de-agglomeration agent (e.g., degree of acidity, basicity, nucleophilicity, electrophilicity, degree of oxidizing potential, and degree of reducing potential); and degree of voltage and current of the applied electrical potential. The mechanical shear preferably is applied by subjecting the test mixture to vortexing, shaking, agitating, mixing, milling, sonicating, or a combination thereof. More preferably, the mechanical shear is applied by ultrasonicating the test mixture. Preferably, the length of time the test mixture is subjected to the de-agglomeration/coagulation stress testing condition(s) is 24 hours or less, more preferably 1 hour or less, and still more preferably 5 minutes or less.

As described previously, the invention method employs one or more agglomerates materials. Each agglomerates material independently may be the same as or different than another agglomerates material. The term “agglomerates material” means a clustered particulate composition comprising primary particles, the primary particles being aggregated together in such a way so as to form clusters thereof, at least 50 volume percent of the clusters having a mean diameter that is at least 2 times the mean diameter of the primary particles, and preferably at least 90 volume percent of the clusters having a mean diameter that is at least 5 times the mean diameter of the primary particles. Preferably, the agglomerates material is not carbon black.

Examples of the primary particles are organic polymer resins useful in forming toner particles and pigment particles useful in forming, for example, latex dispersions such as latex paints. Examples of the organic polymer resins are resins, polymers, and polymers selected for toner in U.S. Pat. No. 7,553,595 B2, column 7, line 6, to column 9, line 31. Preferably, the organic polymer resins are useful in forming toner particles such as by a process generally comprising aggregating organic polymer latex particles comprising the polyester or sulfonated polyester polymeric particles with a wax and a colorant in the presence of a coagulant, such as mentioned in U.S. Pat. No. 7,553,595 B2. Examples of the pigment particles are particles of natural pigments such as clays, calcium carbonate, mica, silicas, and talcs; and particles of synthetic pigments such as calcined clays, precipitated calcium carbonate, synthetic silicas, titanium dioxide, and red iron oxide.

Preferably, particle sizes of the agglomerates material is in the range of from 0.1 micrometer (μm; i.e., 100 nanometers (nm)) to 100 μm (i.e., 100,000 nm).

In some embodiments, agglomerates materials have appreciable sedimentation and settlement rates in the liquid diluent, that is to say that within 5 minutes the stressed test mixtures experience a 5% or greater change in optical density upon standing.

Preferably the agglomerates material further comprises one or more additional components, the agglomerates material and additional component(s) together comprising a preferred type of the agglomerates material that is a heterogeneous agglomerates material. The additional components of the heterogeneous agglomerates material also may be referred to herein as a secondary component, tertiary component, quaternary component, etc.). In some embodiments, the heterogeneous agglomerates material consists essentially of the primary particles and five or fewer additional components. In some embodiments, the heterogeneous agglomerates material consists essentially of the primary particles and four or fewer additional components. In some embodiments, the heterogeneous agglomerates material consists essentially of the primary particles and three or fewer additional components. In some embodiments, the heterogeneous agglomerates material consists essentially of the primary particles and two or fewer additional components. As used in this context, the term “consists essentially of” means that the heterogeneous agglomerates material can contain the primary particles, additional component(s) (up to the specified number thereof), and any other inert component that does not substantially affect (e.g., 5% difference between with and without inert component) average particle size of the heterogeneous agglomerates material. Examples of such inert component are an inert type of the liquid diluent; and residues of an unreacted starting material (e.g., an organic monomer for making an organic polymer) or reaction component (e.g., reaction catalyst, gas atmosphere, or reaction solvent) used in the preparation of the heterogeneous agglomerates material or a component thereof.

In some embodiments, the agglomerates material is the heterogeneous agglomerates material, the heterogeneous agglomerates material consisting essentially of the primary particles and the secondary component. An example of the agglomerates material consisting essentially of the primary particles and the secondary component is a heterogeneous agglomerates material consisting essentially of the pigment primary particles and a latex binder. The term “latex binder” means a polymeric substance that functions in such a way so as to cause at least some of the pigment primary particles to form or collect together into a mass (e.g., a rounded mass) of clustered particles such that average size of the clustered pigment primary particles being larger than average size of the pigment primary particles. Latex binders are known such as, for example, in Examples of the polymeric substance are butadiene copolymers (e.g., copolymers having residuals of two or more monomers, at least one monomer being butadiene; e.g., styrene-butadiene copolymers); acrylic acid copolymers (e.g., copolymers having residuals of two or more monomers, at least one monomer being acrylic acid); and vinyl copolymers (e.g., copolymers having residuals of two or more monomers, at least one monomer being vinyl chloride or vinyl acetate).

In some embodiments, the agglomerates material is the heterogeneous agglomerates material, the heterogeneous agglomerates material consisting essentially of the primary particles, the secondary component, and the tertiary component. In some embodiments, the primary particles are pigment primary particles, the secondary component is the latex binder, and the tertiary component is a latex stabilizer. The term “latex stabilizer” means a substance that inhibits coagulation or agglomeration of the aforementioned clustered particles. Latex stabilizers are known such as, for example, in U.S. Patent Number U.S. Pat. No. 4,110,293. Examples of suitable latex stabilizers are proteins (e.g., gelatin and caseinate salts), carbohydrates (e.g., pectinates), glycols, and surfactants. Examples of suitable surfactants are anionic (i.e., sulfate, sulfonate, or carboxylate containing) surfactants such as perfluorooctanesulfonate; cationic (i.e., quaternary ammonium containing) surfactants such as cetyl trimethylammonium bromide; zwitterionic (i.e., amphoteric) surfactants such as coco ampho glycinate; and nonionic surfactants such as alkyl poly(ethylene oxide) and cetyl alcohol. Nonionic surfactants are preferred. Commercially available latexes typically contain latex stabilizers in amounts suitable for the present invention. In some embodiments, additional amounts of latex stabilizers or additional latex stabilizers can be added when preparing the heterogeneous agglomerates material.

In some embodiments, the agglomerates material is the heterogeneous agglomerates material, the heterogeneous agglomerates material consisting essentially of the primary particles, the secondary component, the tertiary component, and optionally one or more additional components. In such embodiments, preferably the heterogeneous agglomerates material comprises toner particles. Examples of such toner particles are the heterogeneous agglomerates material consisting essentially of, or formed from, the organic polymer resin (the primary particles), a wax (the secondary component), and a colorant (the tertiary component). In such embodiments, preferably the toner particles further comprise, or are formed from a further component that is, a coagulant (the quaternary component) and, optionally, other components (e.g., additional coagulants and surfactants) suitable for forming toner particles. Examples of the wax are the waxes mentioned U.S. Pat. No. 7,553,595 B2, column 10, lines 7 to 59. Examples of the colorant are the colorants mentioned U.S. Pat. No. 7,553,595 B2, column 11, line 1, to column 12, line 35. Examples of the coagulant are the coagulants mentioned U.S. Pat. No. 7,553,595 B2, column 12, lines 45 to 67.

In some embodiments, the agglomerates material contains or is formed from an organic polymer, the organic polymer being characterizable as having a glass transition temperature (or melting temperature) and the temperature of the de-agglomeration/coagulation stress testing condition is characterizable as being less than the glass transition temperature (or melting temperature) of the agglomerates material.

As described previously, the invention method employs one or more test mixtures, each test mixture independently comprising the agglomerates material and the liquid diluent. Each test mixture independently may be the same as or different than another test mixture. In some embodiments, the agglomerates material is characterizable as having less than 1 weight percent carbon black. Preferably, the test mixture is characterizable as having less than 1.0 weight percent (wt %) carbon black, more preferably less than 0.1 weight percent carbon black, and still more preferably the test mixture lacks carbon black.

The test mixture preferably has 50 weight percent (wt %) or less of solids content, more preferably, 10 wt % or less, and still more preferably 5 wt % or less. The test mixture preferably has 0.1 wt % or more, more preferably 0.5 wt % or more, and still more preferably 1 wt % or more solids content. Preferably, the test mixture has a total volume of 3 milliliters (mL) or less. Also preferably, the test mixture has a total volume of 0.1 mL or more. Preferably, the test mixture is characterizable as having a pH of from 2 to 12. In some embodiments, the invention method further comprises a step of diluting the test mixture with a liquid diluent before determining the particle sizes of the agglomerates material thereof. In other embodiments, the particles sizes of the agglomerates material of the test mixture are determined with undiluted test mixture.

In some embodiments, the agglomerates material is not uniformly dispersed in the liquid diluent when particle sizes thereof are determined. In practice, certain types of agglomerates material can sediment in the liquid diluent before particle sizes thereof can be determined. An advantage of the invention method is that it is suitable for determining agglomerates stability of agglomerates materials in sedimentated form, i.e., where the test mixture, at least when it is subjected to particle size determination, comprises sedimentated agglomerates materials in the liquid diluent (e.g., sedimentated agglomerates materials in bottoms of containers holding the test mixtures). That is, the invention method is useful for determining particle sizes of agglomerates materials in sedimentated test mixtures. Examples of types of agglomerates materials that sediment before their particle sizes can be determined are those having particle sizes too large to be uniformly suspended in the liquid diluent and those that comprise test mixtures having high weight percentages (e.g., 1 wt % or higher) thereof (e.g., are unsuitable for optical density analysis).

In some embodiments, the test mixture (i.e., pre-test and stressed test mixture) comprises an essentially uniform dispersion of the agglomerates material in the liquid diluent. Preferably, the uniformly dispersed test mixture lacks an ingredient characterizable as functioning as a dispersant-stabilizer, which can confound the invention method.

As described previously, the invention method employs one or more liquid diluents. Each liquid diluent independently may be the same as or different than another liquid diluent. The term “liquid diluent” means a compound that is characterizable as being in the form of a liquid substance at the temperature of the de-agglomeration/coagulation stress testing condition. Preferably, the liquid diluent is characterizable as having a molecular weight of less than 500 grams per mole (g/mol), more preferably less than 250 g/mol, still more preferably less than 200 g/mol, and even more preferably less than 150 g/mol. Examples of the liquid diluent are water; an organic solvent such as methanol, ethanol, 2-propanol, glycol, toluene, ethyl acetate, acetone, and tetrahydrofuran; and a combination thereof. The instant invention contemplates liquid diluents that, in some embodiments, also function as a solvent, and thus contain one or more solutes dissolved therein.

An example of the test mixture is a first organic polymer latex consisting essentially of a colloidal suspension in water (the liquid diluent) of primary particles that are one of the aforementioned pigment primary particles. Another example of the test mixture is a second organic polymer latex consisting essentially of a colloidal suspension in water (the liquid diluent) of primary particles that are one of the aforementioned pigment primary particles; the latex binder; and, optionally, the latex stabilizer. Still another example of the test mixture is the heterogeneous agglomerates material that consists essentially of one of the aforementioned toner particles in water.

Organic polymer latexes comprise natural organic polymer latexes (e.g., produced from hevea brasilienesis rubber tree) or, preferably, synthetic organic polymer latexes. In some embodiments, the organic polymer latexes useful in the present invention are water-borne organic polymer latexes. The term “water-borne organic polymer latex” means a dispersion of microparticles of the organic polymer described previously in a liquid substance, the liquid substance having a molecular formula of H₂O. Preferred water-borne organic polymer latexes are aqueous dispersions of microparticles of polypropylene, polybutylene, polystyrene, or poly(styrene-butadiene). In some embodiments, the organic polymer latexes useful in the present invention are latex powders, the latex powders being dispers able in the liquid diluent. Where the liquid diluent is or comprises mostly water, the latex powders are redispersible in water. At least some latex powders are commercially available from, for example, Dow Wolff Cellulosics, a business unit of The Dow Chemical Company, Midland, Mich., USA. In some embodiments, the organic polymer latexes useful in the present invention are a combination comprising a water-borne organic polymer latex and an organic polymer latex powder.

As described previously, in some embodiments the invention method employs one or more chemical de-agglomeration agents. Each chemical de-agglomeration agent may be the same as or different than another chemical de-agglomeration agent. The term “chemical de-agglomeration agent” means a compound or substance that is being tested for a probability or characteristic of facilitating breaking of the agglomerates material of the test mixture to break into smaller size particles. In some embodiments, the chemical de-agglomeration agent is characterizable as having a molecular weight of less than 10,000 grams per mole (g/mol), in other embodiments less than 5000 g/mol, in still other embodiments less than 2000 g/mol, and in even other embodiments less than 1000 g/mol. Preferably, the chemical de-agglomeration agent and liquid diluent are different. Preferably, the chemical de-agglomeration agent is at least partially soluble in the liquid diluent. Examples of the chemical de-agglomeration agents are components of organic polymer latexes and resins (e.g., additive), components of paints or toners, paint or toner additives, surfactants, polymer cross-linking agents (which react with polymer of primary particles and polymer of latex binder to cross-link same), defoaming agents, repellant agents (e.g., water and oil repellant agents), salts (e.g., flame-retarding and antistatic salts), thickeners (e.g., rheology modifying agents), catalysts (e.g., curing and cross-linking promoters), waxes, coagulants, dispersing agents, acids, bases, dyes and pigments, and fillers (e.g., clays). In some embodiments, the chemical de-agglomeration agent is an acid, more preferably a protic acid (i.e., Bronsted acid) or Lewis acid. Examples of the protic acid are organic protic acids such as acetic acid, trifluoroacetic acid, para-toluenesulfonic acid, methanesulfonic acid, and trifluoromethanesulfonic acid; and inorganic protic acids such as hydrogen chloride, sulfuric acid, and phosphoric acid. Examples of the Lewis acid are zinc chloride (ZnCl₂) and titanium tetrachloride.

In some embodiments, the chemical de-agglomeration agent is a base. Examples of the base are organic bases such as triethylamine and pyridine and inorganic bases such as sodium hydroxide.

In some embodiments, the chemical de-agglomeration agent is a surfactant. Examples of surfactants are anionic surfactants, cationic surfactants, zwitterionic surfactants, and neutral surfactants. Examples of anionic surfactants are surfactants based on sulfate, sulfonate, or carboxylate anions such as sodium dodecylsulfate (SDS), linear alkylbenzenesulfonates (LAS), and perfluorooctanoate (PFO). Examples of cationic surfactants are surfactants based on quaternary ammonium cations such as cetyl trimethylammonium bromide (CTAB). Examples of zwitterionic surfactants are amphoteric compounds such as cocamidopropyl betaine. Examples of neutral surfactants are alkyl poly(ethylene oxide), alkyl polyglucosides, fatty alcohols (e.g., oleyl alcohol), and polysorbates (e.g., Tween 20).

The invention method contemplates procedures wherein additional agglomerates, liquid diluent, chemical de-agglomeration agent, other component, or a combination thereof are added during performance of the de-agglomeration/coagulation stress testing condition portion of the invention method.

The aforementioned term “de-agglomeration stability” means a probability or characteristic of the clusters of the agglomerates material to break into smaller size clusters of the agglomerates material, as measured by mean diameter when the test mixture is subjected to the de-agglomeration stress testing condition. In an extreme de-agglomeration stress testing condition, at least some of the clusters of the agglomerates material can break into the primary particles comprising the agglomerates material. In another extreme de-agglomeration stress testing condition, none of the clusters of the agglomerates material can be detected as being broken into the smaller size clusters of the agglomerates material. Preferably, the de-agglomeration stress testing condition produces a reduction to smaller size clusters that are detectable by the method of the present invention within one standard deviation of the particle size measurement method. The invention method can provide valuable information with mean particle size, as well as the particle size distribution and investigation of particle size modality (monomodal versus bimodal or multimodal particle size distribution).

In another embodiment of the present invention, the present invention is a method for evaluating coagulation stability of an agglomerates material in a test mixture subjected to a coagulation stress testing condition, the test mixture comprising a liquid diluent and agglomerates material, the agglomerates material comprising a particulate solid that is characterizable as having less than 1 weight percent carbon black. Such coagulation would be indicated by an increase in the mean particle size of the clusters of the agglomerates material. The aforementioned term “coagulation stability” means a probability or characteristic of the clusters of the agglomerates material to further cluster into larger size clusters of the agglomerates material, as measured by mean diameter when the test mixture is subjected to the coagulation stress testing condition. The coagulation stability testing method of the present invention is the same as the aforementioned de-agglomeration stability testing method of the present invention except the term “coagulation” replaces the term “de-agglomeration” wherever the latter term appears in the previously described embodiments. Thus, for example, the resulting chemical coagulation method would employ a test mixture comprising the agglomerates material, liquid diluent, and a chemical coagulation agent. Examples of the chemical coagulation agent are another latex binder and an adhesive. Preferably, the chemical coagulation agent is at least partially soluble in the liquid diluent.

While in some embodiments an exact degree of deagglomeration/coagulation can be difficult to determine, different agglomerates materials can be submitted to the same chemical de-agglomeration/coagulation agent or mechanical shear, and their relative sensitivity to de-agglomeration/coagulation can be studied.

In some embodiments, the difference in the statistical characterization of particle sizes of the agglomerates material before and after subjecting a test mixture comprising the agglomerates material contained in a liquid diluent to a de-agglomeration/coagulation stress testing condition is determined by comparing mean particle sizes, median particle sizes, volume percent of particles having a certain diameter or larger, or a combination thereof. Preferably, the difference in before and after volume percents (vol %) of particles having a certain diameter or larger is 50 vol % or greater (e.g., before 95 vol % of particles have particle size larger than 1.668 μm and after 40 vol % have particle size larger than 1.668 μm (95 vol %-40 vol %=55 vol %), or vice versa), and more preferably 80% or greater. Preferably, difference between mean or median particle size values before and after de-agglomeration/coagulation stress testing is at least 2 fold (e.g., mean particle size of agglomerates material in pre-test mixture is 2 times or greater than mean particle size of agglomerates material in stressed test mixture after de-agglomeration stress testing), more preferably at least 3 fold, and still more preferably at least 5 fold.

The invention method preferably employs at least one particle size analyzer means for determining particle sizes, a statistical characterization thereof, or a combination thereof, of the agglomerates material of the test mixtures. The particular particle size analyzer means employed is not critical to the invention method. Preferably, the particular particle size analyzer means variable speed, more preferably, it is commercially available. Examples of commercially available particular particle size analyzer means are an optical image microscope, the Olympus® IX81 Motorized Inverted Microscope, objective LCPLFL 20×, magnification 1.6×, Olympus® Microsuite™ B3SV software (Olympus America Inc., Center Valley, Pa., USA); and a particle size analyzer, the Beckman-Coulter LS230 Particle Size Analyzer with Small Volume Plus, running Coulter® LS230 Version 3.01 software (Beckman Coulter, Inc., Miami, Fla., USA). Other useful imaging devices and particle size analyzers are commercially available.

In some embodiments, the invention method evaluates de-agglomeration/coagulation stability of agglomerates material over time. Such a longitudinal invention method preferably comprises digitally videotaping test mixtures so as to obtain recorded digital video images as a function of time and analyzing the digital videotaped images so as to determine particle sizes or statistical characterizations thereof. In such longitudinal invention method, preferably the particle size analyzer means comprises a DCR-VX2000 NTSC HANDYCAM™ digital video camera and recorder (Sony Corporation, Tokyo, Japan) and ImageJ (Version 1.42k), open source image editing and analysis software, which is in image transferring communication therewith.

The invention contemplates some embodiments will further comprise or employ a means (not shown) of varying the pressure environment, a means (not shown) of heating or cooling the test mixtures, or both. Examples of such means of heating (not shown) are infrared radiation, microwave radiation, hot air environment, a heating bath (e.g., warm water or mineral oil bath), and a container holder capable of holding a plurality of containers, the container holder having a thermostatable heating element (not shown, e.g., electric heating element) disposed therein. Examples of such means for cooling are cold air environment, a cooling bath (an ice/water bath, and the container holder (not shown) having a thermostatable cooling element (not shown, e.g., chilled glycol line). A preferred temperature range for carrying out the invention method is from 0 degrees Celsius (° C.) to 120° C. A constant ambient temperature (e.g., 20° C.) is preferred during the subjecting step. A preferred pressure range for carrying out the subjecting step of the invention method is from 10 kilopascals (kPa) to 200 kPa. A constant ambient pressure (e.g., 101 kPa) is preferred.

Preferably, the invention method employs at least one parallel high throughput workflow system comprising a means for evaluating, in a parallel regime, de-agglomeration/coagulation stabilities of a plurality of agglomerates materials of a plurality of test mixtures. Each of the agglomerates materials may be the same or different and each of the test mixtures may be the same or different. More preferably, the plurality of text mixtures means 6 or more, still more preferably 12 or more, and even more preferably 24 or more test mixtures (e.g., 96 test mixtures). Examples of such a means for evaluating, in a parallel regime, de-agglomeration/coagulation stabilities of agglomerates materials of a plurality of test mixtures are a parallel high throughput particle size analyzer instrument and a microscope imaging means and image processing means, which is in image transferring communication therewith. Together, the microscope imaging means and image processing means are capable of capturing, in a parallel regime, images of the agglomerates materials of the plurality of test mixtures (e.g., using a digital camera) and determining, in a parallel regime, sizes, or statistical characterizations thereof, of the agglomerates materials from the images captured thereby. More preferably, the high throughput workflow system further comprises a means for applying mechanical shear to the plurality of test mixtures; a means for dispensing one or more chemical de-agglomeration agents to the plurality of test mixtures; and even more preferably, a combination thereof. Preferably, the means for applying s mechanical hear to the plurality of test mixtures comprises a parallel high throughput ultrasonicator, more preferably a parallel high throughput ultrasonicator having one ultrasound-generating probe per test mixture. An example of the parallel high throughput ultrasonicator having multiple ultrasound-generating probes is the Cole-Parmer 750 CTX ultrasonicator.

Still more preferably, the high throughput workflow system further comprises a means for preparing a plurality of the test mixtures; a plurality of containers, each container being capable of containing one of the test mixtures; a means for heating or cooling the plurality of test mixtures; or a combination thereof. Preferably, the high throughput workflow system further comprises a material dispensing robot (e.g., a Hamilton MICROLAB® STAR robot, Hamilton Company, Reno, Nev., USA) for dispensing samples of, for example, test mixtures, agglomerates materials, liquid diluents, chemical de-agglomeration agents, or a combination thereof, into the plurality of containers.

The term “workflow” means an integrated process comprising steps of experimental design, mixing two or more materials together to give mixtures, independently analyzing the test mixtures to determine one or more characteristics or properties thereof (e.g., agglomerates material particle size), and collecting data from the resulting analyses. In this context, the term “high throughput workflow” means the steps of the workflow are integrated and time-compressed such that an overall time to execute the integrated process of the high throughput workflow is from 2.0 times or more (e.g., 10, 50 or 100 times or more) faster than an overall time to execute a corresponding process of a standard non-high throughput workflow (e.g., any corresponding prior art process). The term “parallel,” unless otherwise indicated, means essentially simultaneously, i.e., not sequential but at least partially overlapping in time. Preferably, parallel means overlapping for a majority of time, and more preferably for substantially an entire time.

### Materials and General Methods

### General Considerations.

Perform particle size analysis using the Beckman-Coulter LS230 Particle Size Analyzer with Small Volume Plus, running Coulter® LS230 Version 3.01 software.

### Preparation 1: Preparation of Agglomerates Material S

Mix 10.0 grams (g) of 10 wt % dispersion of the opacifier UCARHIDE® 4001 (Union Carbide & Plastics Technology Corporation, of The Dow Chemical Company, Midland, Mich., USA) in water and 1.0 g of 0.5 molar (M) aqueous solution of calcium chloride.

### Preparation 2: Preparation of Agglomerates Material Q

Mix 10.0 grams (g) of 10 wt % dispersion of the opacifier UCARHIDE® 4001 (Union Carbide & Plastics Technology Corporation, of The Dow Chemical Company, Midland, Mich., USA) in water and 2.0 g of 2 wt % aqueous solution of cetylpyridinium chloride (CPC) (also known as hexadeceylpyridinium chloride).

### EXAMPLE(S) OF THE PRESENT INVENTION

Non-limiting examples of the present invention are described below. In some embodiments, the present invention is as described in any one of the examples.

### Examples 1 to 6

### Chemical De-Agglomeration Stress Testing Conditions (Without Mechanical Shear)

Take one UNIPLATE® microplate (Whatman Inc., (part of GE HealthCare), Piscataway, N.J., USA) (“microplate”). The microplate contains 24 wells, each having a 10 mL volume, in a 4×6 array of four rows A to D and six columns 1 to 6, thereby giving wells A1 to A6, B1 to B6, C1 to C6, and D1 to D6 as shown later in Table 1. The microplate can be used to study 24 same or different test mixtures simultaneously.

Dispense 3 mL of deionized water (a liquid diluent) in wells A1 and A4; 3 mL of aqueous (2 wt %) solution of sodium dodecyl sulfate (2 wt % SDS) in wells A2 and A5; and 3 mL of aqueous (2 wt %) solution of CPC (2 wt % CPC) in wells A3 and A6. Dispense 0.1 mL of Agglomerates Material S in each of the wells A1, A2, and A3; and dispense 0.1 mL of Agglomerates Material Q in each of the wells A4, A5, and A6. Leave wells B1 to B6, C1 to C6 and D1 to D6 empty. Table 1 discloses the composition and well placement of the resulting test mixtures of Examples 1 to 6 in wells A1 to A6, respectively.

TABLE 1
Schematic Representation of test mixtures of agglomerates materials
in 4 × 6 array microplate

| | 1 | 2 | 3 | 4 | 5 | 6 |
|---|---|---|---|---|---|---|
| A | Water + S* | 2 wt % | 2 wt % | Water + | 2 wt % | 2 wt % |
| | | SDS + S | CPC + | Q** | SDS + Q | CPC + Q |
| | | | S | | | |
| B | blank | blank | blank | blank | blank | blank |
| C | blank | blank | blank | blank | blank | blank |
| D | blank | blank | blank | blank | blank | blank |

*S means Agglomerates Material S;
**Q means Agglomerates Material Q
SDS = Sodium dodecyl sulfate;
CPC = Hexadecylpyridinium chloride

Gently stir to mix each of the 6 test mixtures (wells A1 to A6) by using 6 small disposable plastic pipettes, applying zero or minimum mechanical shear. Incubate the resulting test mixtures for about 30 minutes at room temperature.

Dispense one drop of each test mixture onto one of 6 cover slides labeled A1 through A6. Mount each of the cover slides onto an Olympus IX81 optical microscope and capture images of the agglomerates materials of each of the test mixtures using a camera attached to it. The images at a same magnification of 1.6 times for test mixtures of Examples 1 to 6 in wells A1 to A6 are shown in FIGS. 1A1 to 1A6, respectively. In FIGS. 1A1 to 1A6, degree of agglomeration of the test mixtures in wells A1 to A6 can be qualitatively compared by visual inspections thereof.

To obtain particle size distribution data, add test mixture dropwise directly from the well of the microplate into the top of the small volume module of the Beckman Coulter® LS230 particle size analyzer as described previously, and use the computer software to calculate particle size distribution and degree of agglomeration expressed as volume percent (vol %) versus particle diameter in micrometer. Degree of agglomeration is defined as a volume percent of particles with a particle size larger than 1.668 μm. For each test mixture, the particle size analysis produces a graphical plot of vol % on a scale of from 0 vol % to 10 vol % (y-axis) versus particle diameter on a scale of from 0.04 μm to 2000 μm (x-axis) (not shown). Also, results for the test mixtures in wells A1 to A6 of Examples 1 to 6 can be summarized as shown below in Table 2.

TABLE 2
Summary of degree of Agglomeration in test mixtures of agglomerates
materials of Examples 1 to 6 after subjecting them to chemical
stability testing conditions

| | | 2 | | | | |
|---|---|---|---|---|---|---|
| | 1 | (2 wt % | 3 | 4 | 5 | 6 |
| | (Water + | SDS + | (2 wt % | (Water + | (2 wt % | (2 wt % |
| | S) | S) | CPC + S) | Q) | SDS + Q) | CPC + Q) |
| | Vol % | Vol % | Vol % | Vol % | Vol % | Vol % |
| A | 98.06 | 7.526 | 100 | 100 | 3.404 | 99.999 |
| B | empty | empty | empty | empty | empty | empty |
| C | empty | empty | empty | empty | empty | empty |
| D | empty | empty | empty | empty | empty | empty |

Analysis of results in Table 2 show that the agglomerates materials in wells A1, A3, A4 and A6 exhibit 98.06 vol %, 100 vol %, 100 vol %, and 99.999 vol % degree of agglomeration respectively. This indicates that Agglomerates material S and Agglomerates material Q are nearly completely stable in water (wells A1 and A4) or in 2 wt % CPC (wells A3 and A6) under the de-agglomeration stress testing conditions. However, the agglomerates materials in wells A2 and A5 exhibit 7.526 vol % and 3.404 vol % degree of agglomeration, respectively. This indicates that the Agglomerates materials S and Q are nearly completely unstable in 2 wt % SDS under the de-agglomeration stress testing conditions.

### Examples 7 to 12

### Mechanical and Chemical De-Agglomeration Stress Testing Conditions

Prepare another microplate with the 6 test mixtures identical to those of Examples 1 to 6 as shown in Table 1. Dispense 3 mL of deionized water in each of the empty wells in rows B, C, and D to prevent overheating and damage of the sonication probes for the wells in rows B, C, and D. Place the plate under a Cole-Palmer Ultrasonicator having a holder with 24 sonication probes (4×6 array) in such a way that all 24 probes are submerged in the center of each well. Sonicate the test mixtures for 1 minute. Allow the test mixtures to cool for about 15 seconds. Repeat the sonication step for 1 minute.

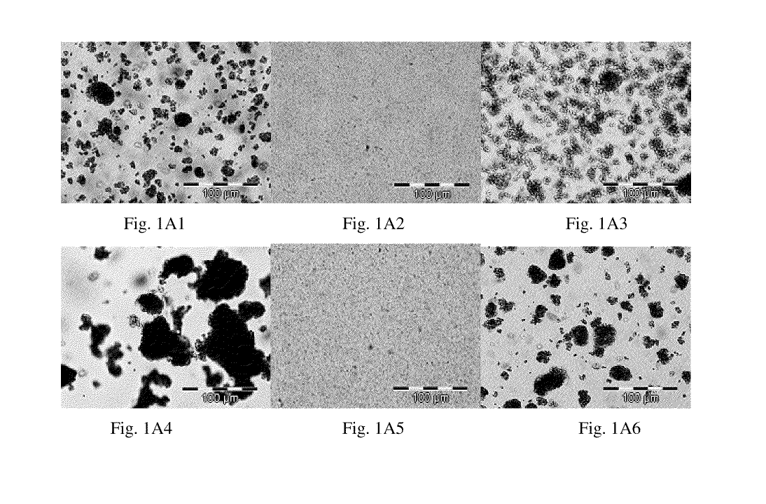

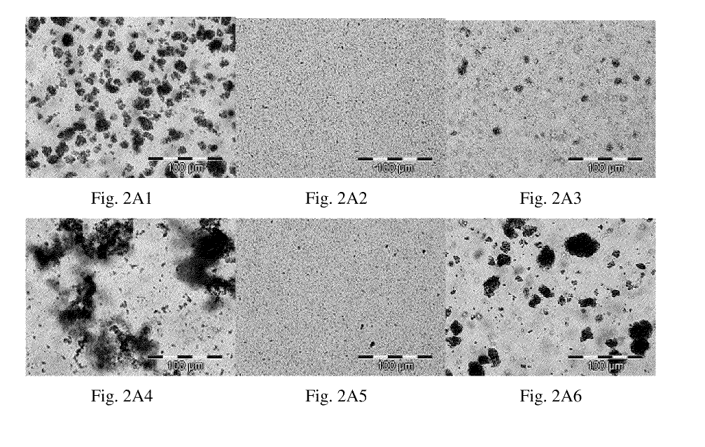

Image each test mixture and determine particle sizes as described previously for Examples 1 to 6. The images at a same magnification of 1.6 times for test mixtures of Examples 7 to 12 in wells A1 to A6 are shown in FIGS. 2A1 to 2A6, respectively. In FIGS. 2A1 to 2A6, degree of agglomeration of the test mixtures in wells A1 to A6 can be qualitatively compared by visual inspections thereof.

For each test mixture, the particle size analysis produces a graphical plot of vol % on a scale of from 0 vol % to 10 vol % (y-axis) versus particle diameter on a scale of from 0.04 μm to 2000 μm (x-axis) (not shown). Also, results for the test mixtures in wells A1 to A6 of Examples 7 to 12 can be summarized as shown below in Table 3.

TABLE 3
Summary of degree of Agglomeration in test mixtures of agglomerates
materials of Examples 7 to 12 after subjecting them to chemical and
mechanical stability testing conditions.

| | | 2 | | | | |
|---|---|---|---|---|---|---|
| | 1 | (2 wt % | 3 | 4 | 5 | 6 |
| | (Water + | SDS + | (2 wt % | (Water + | (2 wt % | (2 wt % |
| | S) | S) | CPC + S) | Q) | SDS + Q) | CPC + Q) |
| | Vol % | Vol % | Vol % | Vol % | Vol % | Vol % |
| A | 88.77 | 6.125 | 34.57 | 97.43 | 2.702 | 95.38 |
| B | Water | Water | Water | Water | Water | Water |
| | blank* | blank | blank | blank | blank | blank |
| C | Water | Water | Water | Water | Water | Water |
| | blank | blank | blank | blank | blank | blank |
| D | Water | Water | Water | Water | Water | Water |
| | blank | blank | blank | blank | blank | blank |

*Water blank means a well is filled with water for protection of a sonicator probe.

Analysis of the results shown in Table 3 show that the agglomerates materials in well A1 exhibits 88.77 vol % degree of agglomeration, thus indicating that there is a moderate deagglomeration in water after sonication when compared with the respective agglomerates material in well A1 of Table 2 (without sonication). Agglomerates materials in wells A2 and A5, which correspond to agglomerates materials that are de-agglomerated in chemical testing (without sonication) as shown previously in Table 2, exhibit further deagglomeration after sonication indicating that both Agglomerates Materials S and Q are unstable 2 wt % SDS, without or with sonication. Test mixture in well A3 of Table 3 after sonication exhibits 34.57 vol % degree of agglomeration compared to 100 vol % degree of agglomeration in Table 2 (without sonication) indicating that the Agglomerates Material S is unstable in mechanical and chemical de-agglomeration stress testing condition. Agglomerates materials in wells A4 and A6 exhibit 97.43 vol % and 95.38 vol % degree of agglomeration respectively, indicating that the Agglomerates Material Q is substantially stable in 2 wt % CPC even after sonication.

As shown be the Examples, the invention method is useful in any procedure, process, or method that could benefit from evaluating de-agglomeration/coagulation stability of agglomerates material. The invention method is especially useful in manufacturing operations such as, for example, agglomerates material manufacturing and manufacturing operations employing agglomerates material as a feedstock. The invention method is particularly beneficial to such manufacturing operations having at least one result-effective variable, where the at least one result-effective variable is capable of being modified (e.g., improved) based on a learning of the de-agglomeration/coagulation stability of agglomerates material. Thus, in some embodiments, the invention method is useful in a quality control/quality assurance paradigm. The invention method is adaptable for use in a laboratory-scale version of a parallel high throughput chemistry system comprising a parallel high throughput testing workflow. Such parallel high throughput testing workflow would be especially useful as a means for accelerating materials and formulations research and development.

While the invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

1. A method for evaluating de-agglomeration/coagulation stability of an agglomerates material, the method comprising evaluating de-agglomeration/coagulation stability of an agglomerates material as a function of a difference in particle sizes, or a statistical characterization thereof, of the agglomerates material before and after subjecting a test mixture comprising the agglomerates material contained in a liquid diluent to a de-agglomeration/coagulation stress testing condition.

2. A parallel high throughput method for evaluating de-agglomeration/coagulation stability of a plurality of agglomerates materials, the method comprising independently evaluating de-agglomeration/coagulation stability of each of a plurality of agglomerates materials as a function of a difference in particle sizes, or a statistical characterization thereof, of the agglomerates material before and after essentially simultaneously subjecting a plurality of test mixtures, each test mixture independently comprising a different one of the plurality of the agglomerates materials contained in a liquid diluent, to a de-agglomeration/coagulation stress testing condition.

3. The method as in claim 1, the de-agglomeration/coagulation stress testing condition comprising a mechanical de-agglomeration stress testing condition, chemical de-agglomeration stress testing condition, electrical stress testing condition, or a combination thereof.

4. The method as in claim 3, the de-agglomeration/coagulation stress testing condition comprising the mechanical de-agglomeration stress testing condition, the mechanical de-agglomeration stress testing condition comprising shear.

5. The method as in claim 4, for each agglomerates material the method independently comprising:
(a) providing a pre-test mixture comprising the agglomerates material and the liquid diluent, the agglomerates material being contained in the liquid diluent;
(b) determining particle sizes, or the statistical characterization thereof, of the agglomerates material in the pre-test mixture;
(c) subjecting the pre-test mixture to the mechanical de-agglomeration stress testing condition, thereby producing a mechanically stressed test mixture comprising a mechanically stressed agglomerates material and the liquid diluent, the mechanically stressed agglomerates material being contained in the liquid diluent;
(d) determining particle sizes, or the statistical characterization thereof, of the mechanically stressed agglomerates material of the mechanically stressed test mixture; and
(e) determining at least one difference in the particle sizes, or the statistical characterizations thereof, between the agglomerates material of the pre-test mixture and the mechanically stressed agglomerates material of the mechanically stressed test mixture.

6. The method as in claim 3, the de-agglomeration/coagulation stress testing condition comprising the chemical de-agglomeration stress testing condition, the test mixture further comprising at least one chemical de-agglomerating agent.

7. The method as in claim 6, for each agglomerates material the method independently comprising:
(a) providing a pre-test mixture comprising the agglomerates material and the liquid diluent, the agglomerates material being contained in the liquid diluent;
(b) determining particle sizes, or the statistical characterization thereof, of the agglomerates material in the pre-test mixture;
(c) contacting the agglomerates material in the pre-test mixture to the at least one chemical de-agglomeration agent, thereby producing a chemically stressed test mixture comprising a chemically stressed agglomerates material, the liquid diluent, and the chemical de-agglomeration agent, or a reaction product thereof, the chemically stressed agglomerates material being contained in the liquid diluent;
(d) determining particle sizes, or the statistical characterization thereof, of the chemically stressed agglomerates material of the chemically stressed test mixture; and
(e) determining at least one difference in the particle sizes, or the statistical characterizations thereof, between the agglomerates material of the pre-test mixture and the chemically stressed agglomerates material of the chemically stressed test mixture.

8. The method as in claim 7, wherein the contacting step essentially lacks mechanical shear of a mechanical de-agglomeration stress testing condition.

9. The method as in claim 3, the de-agglomeration/coagulation stress testing condition comprising the mechanical and chemical de-agglomeration stress testing conditions, the mechanical de-agglomeration stress testing condition comprising shear and the test mixture further comprising at least one chemical de-agglomerating agent.

10. The method as in claim 9, for each agglomerates material the method independently comprising:
(a) providing a pre-test mixture comprising the agglomerates material and the liquid diluent, the agglomerates material being contained in the liquid diluent;
(b) determining particle sizes, or the statistical characterization thereof, of the agglomerates material in the pre-test mixture;
(c) contacting the agglomerates material in the pre-test mixture to a chemical de-agglomeration agent, thereby producing a chemically stressed test mixture comprising a chemically stressed agglomerates material, the liquid diluent, and the chemical de-agglomeration agent, or a reaction product thereof, the chemical de-agglomeration agent and the liquid diluent being the same or different, the chemically stressed agglomerates material being contained in the liquid diluent;
(d) subjecting the chemically stressed test mixture to the mechanical stress testing condition, thereby producing a chemically and mechanically stressed test mixture comprising a chemically and mechanically stressed agglomerates material, the liquid diluent, and the chemical de-agglomeration agent, or a reaction product thereof, the chemically and mechanically stressed agglomerates material being contained in the liquid diluent;
(e) determining particle sizes, or the statistical characterization thereof, of the chemically and mechanically stressed agglomerates material of the chemically and mechanically stressed test mixture; and
(f) determining at least one difference in the particle sizes, or the statistical characterizations thereof, between the agglomerates material of the pre-test mixture and the chemically and mechanically stressed agglomerates material of the chemically and mechanically stressed test mixture.

11. The method as in claim 10, wherein the contacting step (c) and subjecting step (d) are essentially simultaneously performed.

12. The method as in claim 1, the step of determining at least one difference in the particle sizes, or the statistical characterizations thereof, comprising comparing mean particle sizes, median particle sizes, volume percent of particles having a certain diameter or larger, or a combination thereof.
